(19) United States
(12) Patent Application Publication
(10) Pub. No.: US 2006/0140180 A1
(43) Pub. Date: Jun. 29, 2006

(54) Device, system and method for pre-caching media content for home entertainment devices and gateways

(76) Inventor: Thomas L. Du Breuil, Ivyland, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/024,112

(22) Filed: Dec. 28, 2004

(51) Int. Cl. H04L 12/50

(52) U.S. Cl. 370/362

(57) ABSTRACT

A device, system and method which enables prompt playback/presentation of remotely located content on a target network content device, regardless of the actual location of the content data in the network or Internet is disclosed. The present invention pre-caches of portion of the remotely located content in a target network content device, where such content is not stored locally in the target network content device, but rather resides in other remote network content device(s) residing on the same network as the target network device (local area network (“LAN”) in a home, for example), or on the Internet, in order to provide seamless, nearly latency free, playback/presentation of such content. Further, the device, system and method of the present invention determines the portion of the content to pre-cache.

### FIELD OF THE INVENTION

The present invention relates to digital data networks. More specifically, the present invention relates to digital data delivery amongst networked devices.

### BACKGROUND OF THE INVENTION

Today there is significant worldwide focus in providing home gateway products which enable seamless easy access to consumer media content (“content”) throughout an end user's home. Such content may include music, photos, and videos. Similarly, there is a significant focus on point solution products that address only a subset of consumer media, namely broadcast video.

Most product approaches in both the gateway products and point solution products categories include a hard drive, and may also include significant dynamic random access memory (“DRAM”) and/or other rewriteable storage media such as FLASH memory, to store the content. Notable examples of this today include personal video recorders (“PVR”), such as TIVO® and REPLAYTV®, for storing broadcast video(s); ESCIENT®, and other audio jukeboxes, for storing music; and personal computers (“PCs”) that are used for storing downloaded music, photos, and videos.

As vendors extend these products to a true whole home media content gateway environment, many vendors are also including interconnections between these products throughout the home, as well as to the Internet. The most common approach in this regard is to include network functionality into these products (“network content devices”) to enable data exchange therebetween. Such interconnectivity is needed to reach the ultimate undertaking which is to allow these network content devices to share content. (For purposes described below, assume that each network content device has its own local non-volatile memory storage, e.g., a hard drive, EEPROM and FLASH memory, etc.)

For example, if your entire music collection resides on your PC (a network content device) in MP3 formatted files, then a “target” network content device (another network content device which the end user selects for the actual playback of the content), capable of playing back MP3 audio files, should be able to access the MP3 audio files on your PC for data delivery and playback at the target network content device. Such networking has already proved to be successful amongst network content devices in the home, as well as those interconnected to the Internet. However, there exists a significant problem in terms of initial latency in playback/presentation of the desired content at the target network content device.

Specifically, if the desired content data needed is remotely located in another accessible network content device, the target network content device must request and receive the content data from that other accessible network content device. In this request and receive process latency exists. Such latency is often substantial, as the target network content device first attempts to locate which other network content device has the desired content. Further, additional latency also occurs due to the time needed to establish a connection between the target network content device and the other network content device storing the desired content, as well as time to receive the first packet of data in the target network content device.

Thus, while a target network content device may ultimately have access to all content residing in other network content devices on its network, or Internet media content server(s), gaining access to such content data may be less than seamless due to the latency described above.

What is needed is a device, system and method to enable prompt playback/presentation of remotely located content on a target network content device, regardless of the actual location of the content data in the network or Internet.

### SUMMARY OF INVENTION

An object of the present invention is to enable prompt playback/presentation of remotely located content on a target network content device, regardless of the actual location of the content data in the network or Internet.

In order to achieve this objective, as well as others which will become apparent in the disclosure below, the present invention provides a device, system and method which pre-caches a portion of content in a target network content device, where such content is not natively stored locally in the target network content device, but rather resides in another network content device(s) residing on the network of the target network content device (intranet or local area network (“LAN”) in a home, for example), or on an Internet media content server(s), in order to provide seamless, nearly latency free, playback/presentation of such content.

In addition, the present invention provides a device, system and method for determining the portion (amount) of the content to pre-cache.

The present invention advantageously enables a lower cost network-content device to have true seamless accessibility to huge content library contained in other higher cost and more sophisticated network content devices, as if the lower cost network content device had the content stored locally, and provides nearly instant responsiveness to the end user.

In an exemplary embodiment of the present invention, a plurality of network content device reside in a system. Each network content device which is a target network content device (a network content device, which an end user would like to use for playback/presentation of content which is remote to the device itself) employs the inventive method of the present invention, where each target network content device stores a portion, beginning seconds to minutes (depending on content type, e.g. music, video, etc.), of each piece of all accessible in-network (intranet, LAN, in-home, etc.) content and Internet content (to which the consumer is authorized and has expressed interest in playing back), in its local memory storage. In addition, the present invention provides for storing metadata related to each content including the media title, description, parental ratings, actual location on the network or on the Internet, etc. to allow for easy of searching.

Thus, the device, system and method of the present invention enables prompt playback/presentation of remotely located content on a target network content device, regardless of the actual location of the content data in the network or Internet.

### BRIEF DESCRIPTION OF THE DRAWINGS

For a complete understanding of the present invention and the advantages thereof, reference is now made to the following description taken in conjunction with the accompanying drawings in which like reference numbers indicate like features, components and method steps, and wherein:

FIG. 1 is an illustration of a system for enabling prompt playback/presentation of remotely located content on a target network content device, regardless of the actual location of the content data in the network or Internet in accordance with an exemplary embodiment of the present invention;

FIG. 2 is flow diagram of the identification of available content in a network method in accordance with an exemplary embodiment of the present invention;

FIG. 3 is a diagram of the timing sequence of the method to determined the pre-cache amount for an available content in accordance with an exemplary embodiment of the present invention; and

FIG. 4 is a diagram of the timing sequence of the method, within a target network content device, for enabling prompt playback/presentation of remotely located content on a target network content device, regardless of the actual location of the content data in the network or Internet, in accordance with an exemplary embodiment of the present invention.

### DESCRIPTION OF A PRESENTLY PREFERRED EMBODIMENT

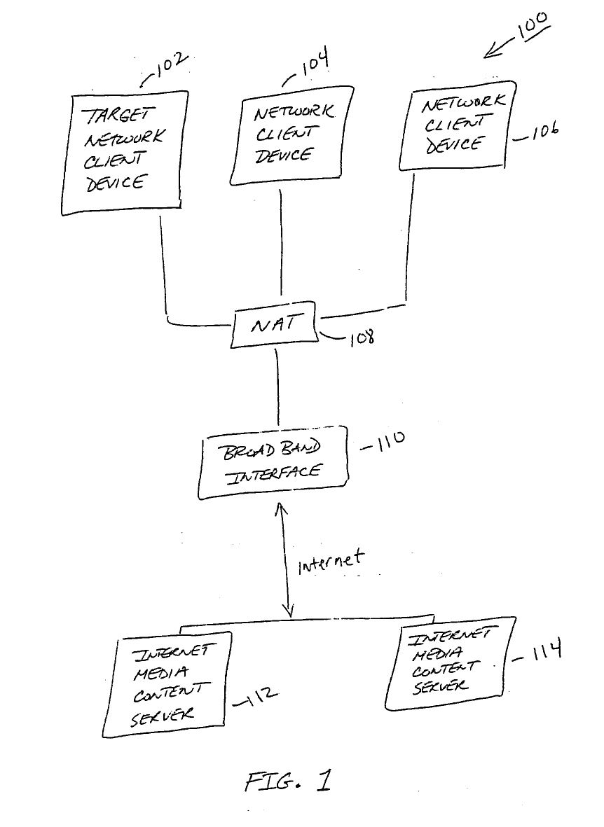

Referring to FIG. 1, a system 100 is shown. System 100 is an inventive system which enables prompt playback/presentation of remotely located content on a target network content device, regardless of the actual location of the content data in the network or Internet. In accordance with an exemplary embodiment of the present invention, system 100 includes a plurality of network content devices (“NCD”) 102, 104, 106, a network address translator with router and dynamic host configuration protocol server (“NAT device) therein (“NAT device) 108, a broadband interface 110, and plurality of Internet media content servers (“IMCS”) 112, 114.

Of NCDs 102, 104, 106, at least one NCD 102, 104, 106 is a “target” network content device (“TNCD”, an NCD the end user selects for the actual playback of the content which is remote to the TNCD itself), in this case TNCD 102. (Please note that multiple TNCDs may be employed at the same time, where each TNCD outputs end user desired content in real-time via its playback/presentation components. Thus, in a given system all NCDs can be TNCDs if the end user so desires.) Further each NCD 102, 104, 106 contains at least one non-volatile memory storage component therein and the ability to playback/present at least one type content, e.g., MPEG-2, MPEG-4, MP3, AAC, JPEG, DV or DVI, etc.

For purposes of this exemplary embodiment, TNCD 102 and NCDs 104, 106 are communicatively coupled to each other in a local area network (“LAN”) via NAT device 108. Please note that while described in the context of a LAN, TNCD 102 and NCDs 104, 106 can be networked in other network configurations, such as a wide area network, intranet, etc.

NAT device 108 is interconnected to broadband interface 110. Broadband interface 110 provides the NAT device's 108 clients (TNCD 102 and NCDs 104, 106) with access to the Internet and to Internet content contained on a plurality of IMCSs 112, 114.

Please note, FIG. 1 is simply one exemplary embodiment of the present invention. Many different configurations may be utilized still keeping with the spirit of the present invention. For example, the present invention may be implemented without a broadband interface 110 and access to IMCS 112, 114, for example.

In order to enable prompt playback/presentation of content on TNCD 102, regardless of the actual location of the content data in the network or Internet, the present invention requires the identification of remotely located content to be played/presented on TNCD 102; determination of the amount of each piece of content to pre-cached by TNCD 102, followed by the actual pre-caching in accordance with the present inventive technique; and the actual playback/presentation of desired remotely located content using the pre-cached portion as a trail in, to the content being streamed in from the remote source, to make the inherit latency (described above) nearly invisible to the end user at TNCD 102 in accordance with this exemplary embodiment of the present invention.

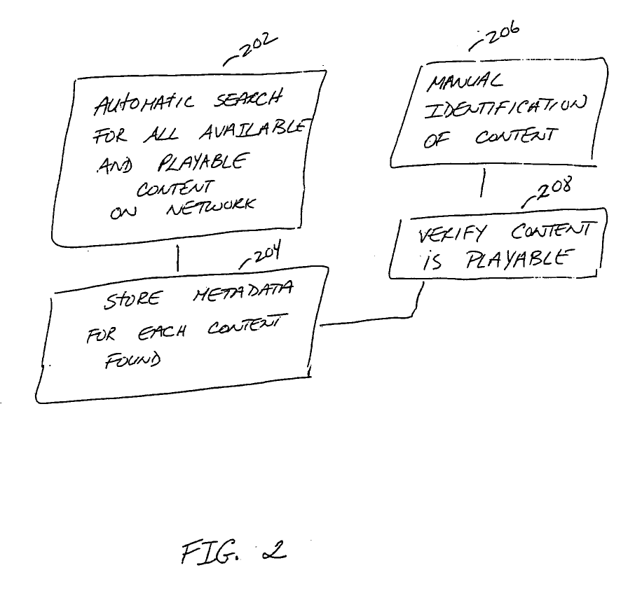

Referring to FIG. 2, the remote content (“content”) available in other NCDs 104, 106 on the LAN must be identified by TNCD 102. This process is a combination of available content and the type(s) of content TNCD 102 can playback/present. Solely for explanatory purposes only, assume that TNCD 102 has the capability to playback/present MPEG-2 video and MP3 audio. The identification process can begin in one of two ways. First, TNCD 102 can automatically search the LAN for all available MPEG-2 and MP3 files, in step 202. Upon finding a MPEG-2 or MP3 file, TNCD 102 stores metadata related to each MPEG-2 and MP3 file including the media title, description, parental ratings, location on the LAN (in which other NCD 104, 106), etc. to allow for easy of searching thereafter, in step 204. Techniques for this identification step are known by those skilled in the art. Alternatively, an end user can manually identify these remote content files, in step 206, where TNCD 102 still only accepts identification of MPEG-2 and MP3 files due to its playback/presentation capabilities described above, in step 208. Thereafter, TNCD 102 stores metadata related to the manually identified MPEG-2 or MP3 files including the media title, description, parental ratings, location on the LAN (in which other NCD 104, 166), etc. to allow for easy of searching thereafter, in step 204.

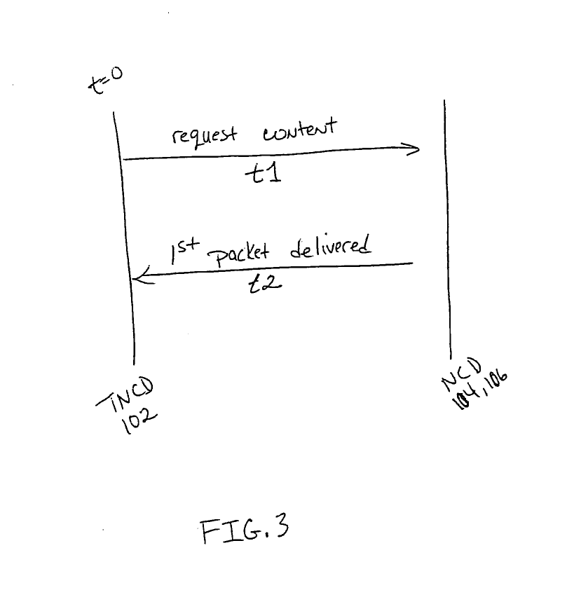

Continuing with the above illustrative example, in terms of determining the amount of data from each MPEG-2 or MP3 files to pre-cache in accordance with the inventive technique of the present invention, the present invention employs the latency test illustrated in FIG. 3. In an exemplary embodiment of the present invention, TNCD 102 searches its metadata (related to the identified remotely available content) and determines which metadata does not have an associated pre-cache content in the memory storage of TNCD 102. For each such file, TNCD 102 attempts to begin remote data delivery from the actual NCD 104, 106 where the content actually resides. Assume NCD 104 has the file to be pre-cached for this example. TNCD 102 calculates the time it takes to connect to NCD 104, t1. Then TNCD 102 calculate the time it takes the first packet of content data to reach TNCD 102, t2, after the connection (t1). TNCD 102 then adds t1+t2 plus a buffer (tb) to determine a projected latency time, preferably in seconds. Further, tb can be a fixed time for all types of content files, or preferably can be different based upon file type, e.g., for MPEG-4 content tb=4 seconds and for MP3 content tb=2 seconds. Thus, t1+t2+tb is an approximation of the amount of time (latency) needed for the remote content to start up and play smoothly on TNCD 102.

TNCD 102 then multiples the projected latency by the bits per second needed for normal playback of the content file to be pre-cached (this is based upon the real-time playback bandwidth need). The result is number of bits of the content data that TNCD 102 must pre-cache (“pre-cached amount”). Hence:
(t1+t2+tb)*(bits/second of content)=pre-cached amount.

Using the same stream initiated for the test, TNCD 102 preferably, for efficiency purposes, pre-caches the determined pre-cache amount of the content file. The same procedure is conducted for each metadata in TNCD 102 which does not have an associated pre-cached file. Further, the above described inventive test to determine the pre-cached amount is preferably performed when TNCD 102 itself is not otherwise busy.

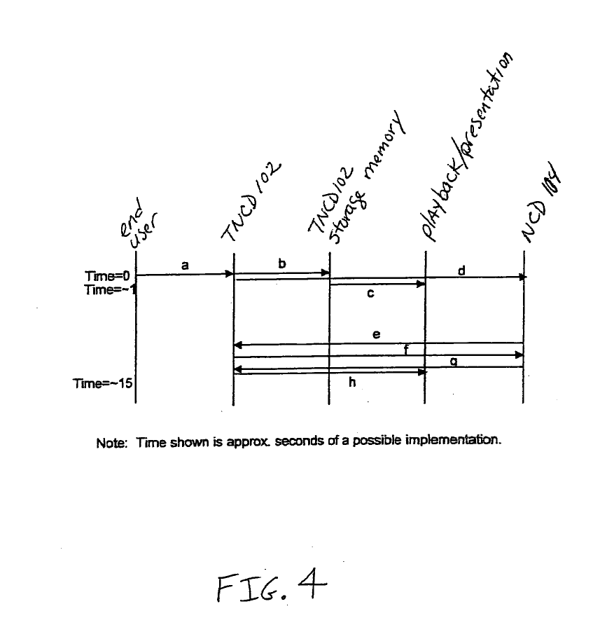

Once all playable content files in the LAN have been identified via metadata in TNCD 102 and each metadata has an assocaited pre-cache file (or for at least the content the end user is desiring in a given instant), referring to FIG. 4, in operation, at time t=0, an end user of TNCD 102 request TNCD 102 to begin playing a selected title using the stored metadata in TNCD 102 (a). Then, TNCD 102 searches its non-violative memory storage, e.g., hard drive, (b) for the appropriate pre-cache file associated with the metadata for the selected title, and then begins presenting the pre-cached content of the selected title (c). At the same time, TNCD 102 sends a request to NCD 104, where the actual content is stored, for delivery of the content of the selected title (d). When the actual content begins streaming from NCD 104, it is sent to TNCD 102 (e), which then requests NCD 104 to fast forward its stream to the appropriate time (f) taking the pre-cache into account. This will effectuate the splice described above. When NCD 104 completes the fast forward (g), TNCD 102 makes sure the actual pre-cache presentation from its local drive is synchronized with the streamed content from NCD 104. TNCD 102 then makes the splice, and forwards all data from NCD 104 directly to the end user for playback/presentation (h).

Please note that there are several possible techniques that could be used to align the splice point between the pre-cached content and the actual content being streamed from the source, NCD 104 in this instance. The best technique is dependent on the particular media type/format although there are multiple choices for many media types. Such splicing choices are easy discernable by those of ordinary skill in the art. In some scenarios, it will require fine grain control over the speed of the actual streamed content from the source to speed it up/slow it down in order to make the splice seamless. In other cases, the best option may be to leave TNCD 102 with a live buffer of a few seconds, and the first time the end user invokes motion control (pause, fast forward, rewind, stop), “splice” to the actual media source, clearing the buffer.

Employing the same inventive techniques described above, the present invention can be used to for content delivery from IMCSs 112, 114. Here, since the Internet is so vast, the end user identifies content which the end user is authorized and has expressed interest in playing back. An example of such content is content from an Internet audio service subscription. TNCD 102 then performs the same steps of creating metadata for each content, determine the pre-cache amount, pre-caching the content consistent with the pre-cache amount, and playing back the content as described above and shown in FIG. 4.

Thus, the device, system, and method of the present invention enables prompt playback/presentation of remotely located content on a target network content device, regardless of the actual location of the content data in the network or Internet, by use of its inventive pre-cache technique. Further, the device, system and method of the present invention determines the portion of the content to pre-cache.

From an end user's perspective, the present invention significantly enhances TNCDs by providing prompt presentation of data from any NCD 104, 106 in the LAN (home). Further, the present invention does not require that all the content be transferred to the hard drive(s) or other memory storage media of each TNCD, which would be a great expense. Another benefit of the inventive “pre-cache” approach described herein is that it attempts to avoids copyright issues on music and video content since only a tiny fraction of the actual content is ever copied to the TNCD, while the bulk of the content can come directly from the original authorized source, e.g., a DVD the end user has purchased residing in a NCD DVD player, or a DRM (Digital Rights Management)-protected MP3 song they have purchased from a service provider residing in a NCD PC.

Although the present invention has been described herein by reference to an exemplary embodiment thereof, it will be understood that such embodiment is susceptible of modification and variation without departing from the inventive concepts disclosed. For example, NCD can be any type of network enabled content device including, but not limited to, CD players, DVD players, television set top boxes, PVRs, PCs, etc. Further, TNCDs can be any type of network enabled content device which includes a non-violative memory storage including, but not limited to, television set top boxes, PVRs, PCs, etc. Content as described above is inclusive of all digital media content. All such modifications and variations, therefore, are intended to be encompassed within the spirit and scope of the appended claims.

We claim:

1. A method for defining a portion of a remotely located content to pre-cache, said method comprising:
making a request from a first network content device to a second network content device for specific content stored on said second network content device;
determining a time t1 of said request;
determining a time t2, said time t2 being a time from time t1 until a first packet of said specific content is delivered to said first network content device from said second network content device; and
determining a bits per second presentation bandwidth of said specific content.

2. The method of claim 1 further comprising the step of determining a pre-cache amount of said specific content, where
(t1+t2)*(bits/second of content)=bits of said specific content to be pre-cached.

3. The method of claim 1 further comprising a buffer time (tb), said time tb being at least one of a pre-determined fixed time and a variable time, said variable time being based upon said bits per second presentation bandwidth of said specific content.

4. The method of claim 1 further comprising the step of determining a pre-cache amount of said specific content, where
(t1+t2+tb)*(bits/second of content)=bits of said specific content to be pre-cached.

5. The method of claim 1 further comprising the step of storing said specific content received in response to said request, where at least a portion of said received specific content is stored to created a pre-cache of said specific content, in said first network content device, in an amount of said pre-cache amount.

6. The method of claim 1 further comprising storing at least one metadata related to said specific content in said first network content device.

7. The method of claim 1, wherein at least one of said steps of said making a request, said determining t1, said determining t2, and said determining bits per second presentation bandwidth of said specific content are performed when said first network content device is idle.

8. The method of claim 1, wherein said specific content is one of a MPEG-2 MPEG-4, MP3, AAC, JPEG, DV or DVI file.

9. A method for defining a portion of a remotely located content to pre-cache, said method comprising:
making a request from a first network content device to an Internet server for specific content stored on said Internet server;
determining a time t1 of said request;
determining a time t2, said time t2 being a time from time t1 until a first packet of said specific content is delivered to said first network content device from said Internet server; and
determining a bits per second presentation bandwidth of said specific content.

10. The method of claim 9 further comprising the step of determining a pre-cache amount of said specific content, where
(t1+t2)*(bits/second of content)=bits of said specific content to be pre-cached.

11. The method of claim 9 further comprising a buffer time (tb), said time tb being at least one of a pre-determined fixed time and a variable time, said variable time being based upon said bits per second presentation bandwidth of said specific content.

12. The method of claim 9 further comprising the step of determining a pre-cache amount of said specific content, where
(t1+t2+tb)*(bits/second of content)=bits of said specific content to be pre-cached.

13. The method of claim 9 further comprising the step of storing said specific content received in response to said request, where at least a portion of said received specific content is stored to created a pre-cache of said specific content, in said first network content device, in an amount of said pre-cache amount.

14. The method of claim 9 further comprising storing at least one metadata related to said specific content in said first network content device.

15. The method of claim 9, wherein at least one of said steps of said making a request, said determining t1, said determining t2, and said determining bits per second presentation bandwidth of said specific content are performed when said first network content device is idle.

16. The method of claim 9, wherein said specific content is one of a MPEG-2 MPEG-4, MP3, AAC, JPEG, DV or DVI file.
